(19) United States
(12) Patent Application Publication
(10) Pub. No.: US 2025/0132594 A1
(43) Pub. Date: Apr. 24, 2025

(54) PREDICTING SMALL CAPACITY BACKUP BATTERY AVAILABILITY

(71) Applicant: Microsoft Technology Licensing, LLC, Redmond, WA (US)

(72) Inventors: Julian Arlo BINDER, Redwood City, CA (US); Kang KANG, Redmond, WA (US)

(21) Appl. No.: 18/382,946

(22) Filed: Oct. 23, 2023

(51) Int. Cl. H02J 7/34; G02B 27/01; G05B 13/02; H02J 7/00

(52) U.S. Cl. CPC H02J 7/34; G05B 13/029; H02J 7/00032; H02J 7/0047; H02J 7/0063; G02B 2027/0163; G02B 27/0176

(57) ABSTRACT

Circuitry configured to determine whether a backup battery is capable of providing power to power a load are provided. A circuit can include a backup battery, a sensor electrically coupled to generate condition data indicative of a condition in an environment of the backup battery, a first current sense device electrically coupled to generate first current data indicative of an amount of current provided to load circuitry, a backup battery controller coupled to the backup battery, sensor, and the first current sense device, the backup battery controller configured to determine based on the condition data and the first current data whether the backup battery is available to provide power to the load circuitry, and provide an electrical signal indicative of whether the backup battery is available to provide the power to the load circuitry.

### BACKGROUND

Backup batteries are generally required to keep an always-on system powered during a main power transition. Batteries, including backup batteries, have limited operating ranges that are affected by environmental factors. Additionally, the age and usage history of the backup battery affects the backup battery performance.

Backup batteries that are large, and have high capacity, are not highly affected by these environmental factors. These high-capacity backup batteries maintain sufficient power density at cold temperatures and under significant aging.

### SUMMARY

Embodiments regard circuits, devices, and methods for determining whether a backup battery is capable of powering a load. A circuit can include a backup battery. A sensor can be electrically coupled to generate condition data indicative of a condition in an environment of the backup battery. A first current sense device can be electrically coupled to the backup battery to generate first current data indicative of an amount of current provided to load circuitry. A backup battery controller can be coupled to the backup battery, sensor, and the first current sense device. The backup battery controller can be configured to determine based on the condition data and the first current data whether the backup battery is available to provide power to the load circuitry. The backup battery controller can be further configured to provide an electrical signal indicative of whether the backup battery is available to provide the power to the load circuitry.

The sensor can be a temperature sensor and the condition data can be temperature data. The sensor can be a battery swell sensor and the condition data can be physical pressure data.

The circuit can further include an analog to digital converter (ADC) configured to provide voltage data indicative of a voltage level of the backup battery. The determination of whether the backup battery is available to provide power to the load circuitry can be further based on the voltage level.

The backup battery controller can implement a neural network that operates on the voltage data, the first current data, and the condition data to make the determination of whether the backup battery is available to provide power to the load circuitry. The backup battery controller can implement a decision tree that operates on the voltage data, the first current data, and the condition data to make the determination of whether the backup battery is available to provide power to the load circuitry.

The backup battery controller can be configured to receive, from a second current sense device, second current data indicative of a current drawn from the backup battery, and the determination of whether the backup battery is available to provide power to the load is further based on the second current data. The backup battery controller can be further configured to responsive to power being drawn by the load circuitry from the backup battery, determine impedances for various times after the power begins being drawn. The determination of whether the backup battery is available to provide power to the load circuitry can be further based on the impedances.

The circuit can be part of a system that includes the load circuitry and a main battery configured to provide power to the load circuitry. The backup battery controller can be configured to provide an electrical signal to the load circuitry indicative of whether the backup battery is available to provide the power to the load circuitry.

### BRIEF DESCRIPTION OF THE DRAWINGS

FIG. 1 illustrates, by way of example, a circuit diagram of an embodiment of a system that includes a backup battery monitoring circuit.

FIG. 2 illustrates, by way of example, a diagram of an embodiment of a state machine that controls operation of the backup battery controller.

FIG. 3 illustrates, by way of example, a diagram of an embodiment of a neural network (NN) configured to determine if the backup battery is available to provide power to the load circuitry.

FIG. 4 illustrates, by way of example, a diagram of an embodiment of a decision tree model that can be used by the backup battery controller to determine whether or not the backup battery can provide power to the load.

FIG. 5 illustrates, by way of example, a diagram of an embodiment of a method for whether a backup battery can provide power to a load.

FIG. 6 is a block diagram of an example of an environment including a system for neural network (NN) training.

FIG. 7 is a block schematic diagram of a computer system for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Certain devices require small backup batteries. A “small backup battery” is defined as a backup battery with a capacity of one fourth of the average maximum load or less. This means the longest amount of time the small backup battery can operate under the average maximum load is fifteen minutes. Small backup batteries are used in handheld devices, mobile devices, and body worn devices where weight and size are key design parameters. Small capacity backup batteries have less available discharge power than larger batteries yet are generally smaller than a primary battery that is suitable for powering the load.

The available discharge power of the backup battery decreases as the temperature lowers. The available discharge power also decreases as the backup battery ages due to increased internal losses. Since the backup battery is not always providing power to the load, it is typically unknown whether the backup battery will operate when it is needed. The backup battery can provide power to the load only after the main battery power is reduced to a point that it no longer can power the load or the main battery is disconnected from the load. The device that might rely on the backup battery for power can benefit from a circuit that determines whether the backup battery can support an unexpected loss of primary power or an unexpected decrease in primary power.

An improved backup battery system formed with circuitry, a state machine, a model, or a combination thereof is provided. The improved backup battery system can accurately predict under what situations (e.g., small capacity, where small capacity means the capacity of the battery in Amp hours is less than, or equal to, a quarter of the power drawn by the load) backup batteries can handle (e.g., and unexpected) loss of power. The circuitry can be housed with the backup battery. The circuitry can measure the voltage, load current (e.g., for driving the backup batter monitoring circuitry), and optionally a condition of an environment about the backup battery pack, and the power consumption of the system. The model can be linearly interpreted based upon a set of characterization data, can include a deep neural network (DNN) trained based on characterization data, or can include any other model configured to determine whether the backup battery is capable of powering the system for a specified amount of time. The model uses the parameters measured by the circuitry, as well as stored and updated impedance values of the backup battery, to predict the success/failure of a backup battery discharge.

A method of updating the impedance of the backup battery during an unexpected loss of power can include taking an initial voltage measurement, a current measurement, and subsequent voltage measurements under load at various times (e.g., 10 ms, 1 s, 15 s, 30 s, or other times after the backup battery begins discharging). Using the current and voltage, the impedance across frequency at the discharge temperature can be determined. Based on a previous characterization of the backup battery, the impedance across a range of temperatures can then be estimated. These updated impedance numbers can be fed back into the model to predict availability for the next backup event.

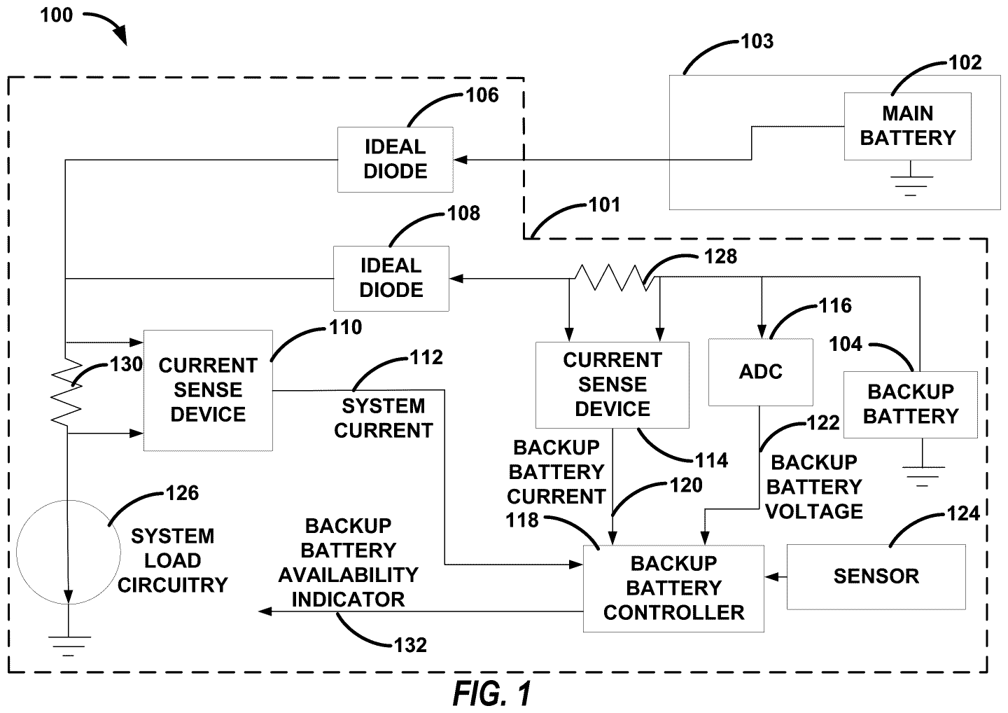

FIG. 1 illustrates, by way of example, a circuit diagram of an embodiment of a system 100 that includes a backup battery monitoring circuit. The system 100 includes a first housing 103 and a second housing 101. The first housing 103 contains a main battery 102 coupled to an ideal diode 106. The ideal diode 106 is electrically coupled to a resistor 130. A current sense device 110 is electrically coupled in parallel to the resistor 130. The resistor 130 is electrically coupled to a load 126. The second housing 101 contains backup battery monitoring circuitry. The backup battery monitoring circuitry includes a backup battery 104 electrically coupled to an analog to digital converter (ADC) 116 and a resistor 128. The ADC 116 and the resistor 128 are electrically coupled in parallel to each other. A current sense device 114 is electrically coupled in parallel to the resistor 128. A backup battery controller 118 is electrically coupled to receive sensor data from a sensor 124, voltage data from the ADC 116, and current data from the current sense device 114.

The backup battery monitoring circuit is situated on, or at least partially in, a housing 101. The housing 101 is separate from another housing 103 that contains or otherwise mechanically supports the main battery 102. The main battery 102 and other components outside of the housing 101 can be situated on or at least partially in another housing 103.

The system 100 includes a main battery 102 coupled to a load 126. The main battery 102 provides electrical power to the load 126. The main battery 102 is typically large and configured to power the load 126 for a specified period of time.

The backup battery circuit in the housing 101 includes backup battery 104. The backup battery 104, relative to main battery 102, is capable of powering the load 126 for less time than the main battery 102. The backup battery 104 is typically small (e.g., has an electrical capacity in terms of Amp hours that is less than, or equal to, ¼ of the average current drawn by the load circuitry 126), which means that the backup battery 104 is capable of powering the average power consumption of the load 126 for a maximum of fifteen minutes in one example. Since the backup battery 104 can be external to a housing 103 in which the load 126 is situated and the backup battery 104 can be worn on the body, it can be beneficial to keep the backup battery 104 lightweight. Lightweight batteries are typically small in size to keep the battery lighter.

The main battery 102 is coupled to an ideal diode 106. The ideal diode 106 prevents current from flowing towards the main battery 102. The ideal diode 106 ensures that a large majority of the current flows from the main battery 102 to the load 126 and not the other way around. The ideal diode 106 provides the function of a normal diode, but with a minimal voltage drop (e.g., less than 0.1 Volts). Ideal diodes are typically formed using a metal oxide semiconductor (MOS) field effect transistor (FET) and a corresponding control circuit. An alternative to the ideal diode 106 can include. Separate circuitry (not shown) can be used to charge one or more of the main battery 102, the backup battery 104, or a combination thereof.

A current sense device 110 measures an amount of current across a resistor 130. The current sense device 110 can include a coulomb counter that measures the average current that passes through the resistor 130. The current sense device 110 can include a differential amplifier providing a voltage whose amplitude represents a system current 112. System current 112 is proportional to the current flowing into the load 126. The system current 112 is provided to a battery backup controller 118 of the backup battery monitoring circuit. When the main battery 102 is providing power to the load 126, the system current 112 indicates the current being drawn from the main battery 102. When the backup battery 104 is providing power to the load 126, the system current 112 indicates the current being drawn from the backup battery 104.

The load 126 typically provides functionality of a body worn device but could be a device that is not body worn. That is, the housing 101 and 103 are typically body worn. Examples of body worn devices include an extended reality (XR) headset, a night vision headset, or other body worn device. With a body worn device, such as a head worn device, the backup battery 104 can be external to the housing 103 for the load 126 but still worn on the body. The weight and size of the backup battery 104 can thus effect user mobility, comfort, or the like. The backup battery 104 is typically internal to the body worn device and the main battery 102 is typically external to the body worn device so as to keep the weight and size of the body worn device lower. The backup battery 104 is smaller and lighter than the main battery 102 and thus can be part of the body worn device without adding too much weight or consuming too much space.

The backup battery monitoring circuit in the housing 101 includes the backup battery 104, a backup battery controller 118, one or more sensors 124, another current sense device 114, and an analog to digital converter (ADC) 116. The backup battery 104 is electrically coupled to the load 126 through another ideal diode 108. The ideal diode 108 ensures that a large majority of current from the backup battery 104 flows from the backup battery 104 to the load 126 and not the other way around.

The ADC 116 converts the analog voltage from the backup battery 104 to a digital value (called a backup battery voltage 122 in FIG. 1) indicative of the amplitude of the analog voltage. The backup battery voltage 122 is provided to the backup battery controller 118.

The current sense device 114 “measures” an amount of current across a resistor 128. The current sense device 110 can include a coulomb counter that measures the average current that passes through the resistor 130. The current sense device 114 can include a differential amplifier providing an analog output voltage (called “backup battery current” 120 in FIG. 1) proportional to the current flowing out of the backup battery 104. The backup battery current 120 is provided to the battery backup controller 118. When the main battery 102 is providing power to the load 126, the backup battery current 120 indicates the current being drawn from the backup battery 102 by components of the backup battery monitoring circuit. When the backup battery 104 is providing power to the load 126, the backup battery current 120 indicates the current being drawn from the backup battery 104 by both the load 126 and the components of the back battery monitoring circuit.

One or more sensors 124 of the backup battery monitoring circuit provide data indicative of one or more respective conditions being experienced by the backup battery monitoring circuit. The sensor 124 can include a temperature sensor, a battery swell sensor, a combination thereof, or the like. The capacity of the backup battery 104 to power the load 126 is dependent on temperature. Similarly, the capacity of the backup battery 104 to power the load 126 can be determined based on battery swell. A physical pressure measurement can be used to determine how much a battery has swelled. The temperature, battery swell (e.g., based on physical pressure), or a combination thereof can be used by the backup battery controller 118 to estimate how long the backup battery 104 can power the load 126.

The backup battery controller 118 can include a microcontroller, an application specific integrated circuit (ASIC), or the like. The backup battery controller 118 receives data from one or more of the current sense devices 110, 114, the ADC 116, or the sensor 124 to generate an indicator 132. The indicator 132 provides a user of the device corresponding to the system load 126 with a signal indicating whether the backup battery 104 can provide power for the load 126 for a specified period of time. The indicator 132 can be at a high voltage level (or a low voltage level if negative logic is used) if the backup battery 104 can provide the power to the load for the specified amount of time. The indicator 132 can be at a low voltage level (or a low voltage level if negative logic is used) if the backup battery 104 cannot provide the power to the load for the specified amount of time. The indicator 132 can drive a light emitting diode (LED) of a body worn device, for example. The LED, when emitting can indicate that the backup battery 104 is or is not capable of powering the load 126. In some instances, the indicator 132 can be input to a controller of the device that draws the load 126. The controller can then cause a visual, haptic, or other indication to the user indicating whether or not the backup battery is available to provide power. In the example of a headset, a graphic depiction, such as a word or symbol, provided by the headset can be provided by the controller to indicate whether the backup battery 104 is available to provide power. The user of the body worn device can thus know whether they can rely on the backup battery 104 or not.

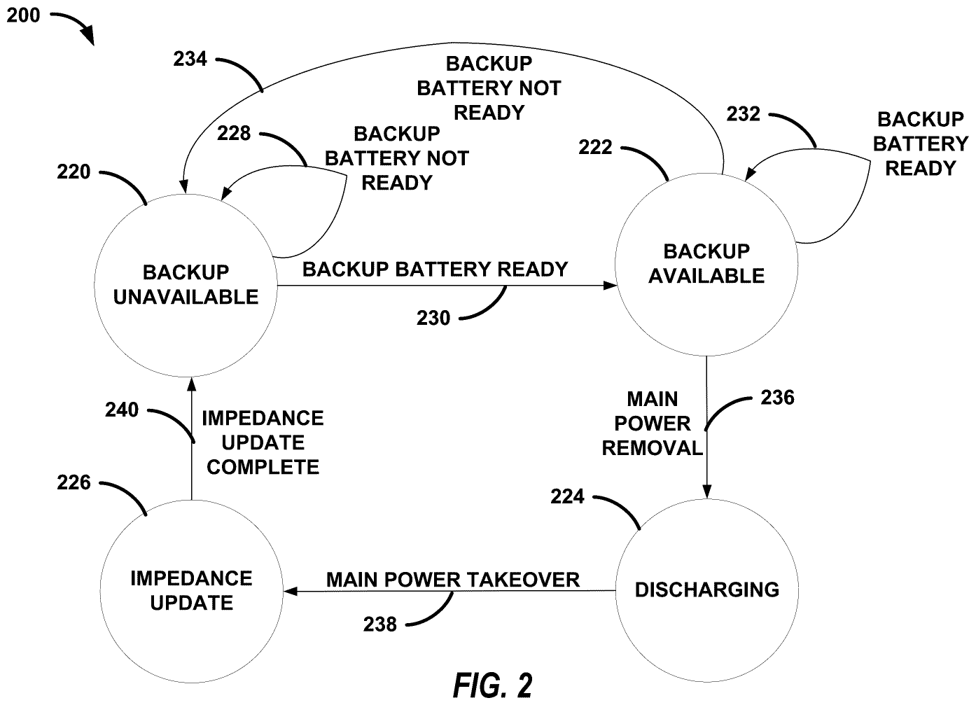

The backup battery controller 118 can include logic gates, other electrical or electronic components, or a combination thereof configured to implement a state machine. The state machine can control the operation of the backup battery controller 118. An example of a state machine is provided in FIG. 2. The logic gates can include AND, OR, XOR, negate, buffer, or other logic gates. The electrical or electronic components can include transistors, resistors, capacitors, diodes, inductors, multiplexers, amplifiers, switches, memory devices, or the like.

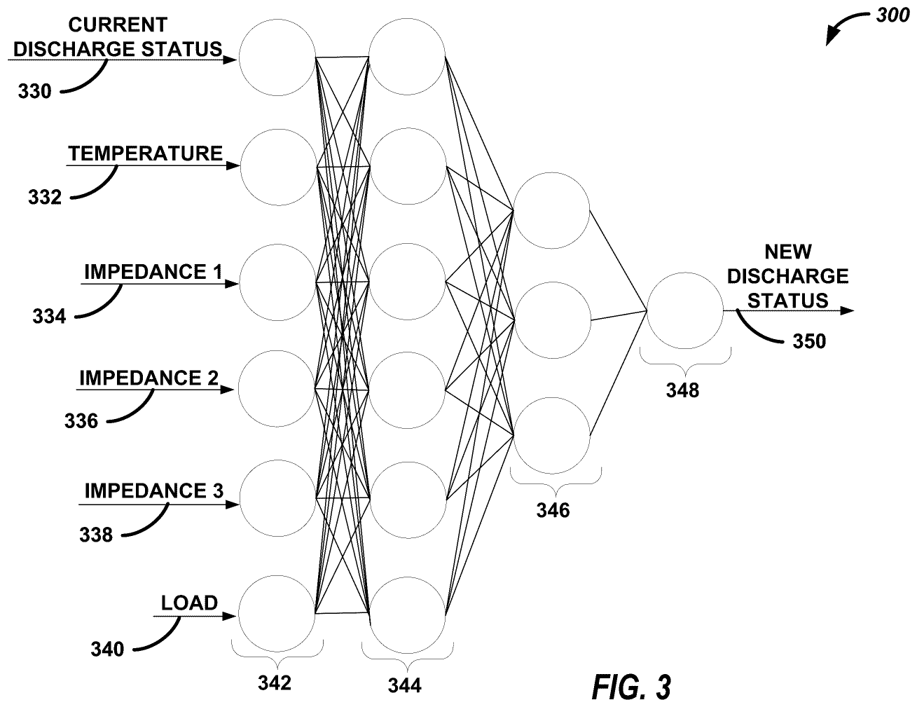

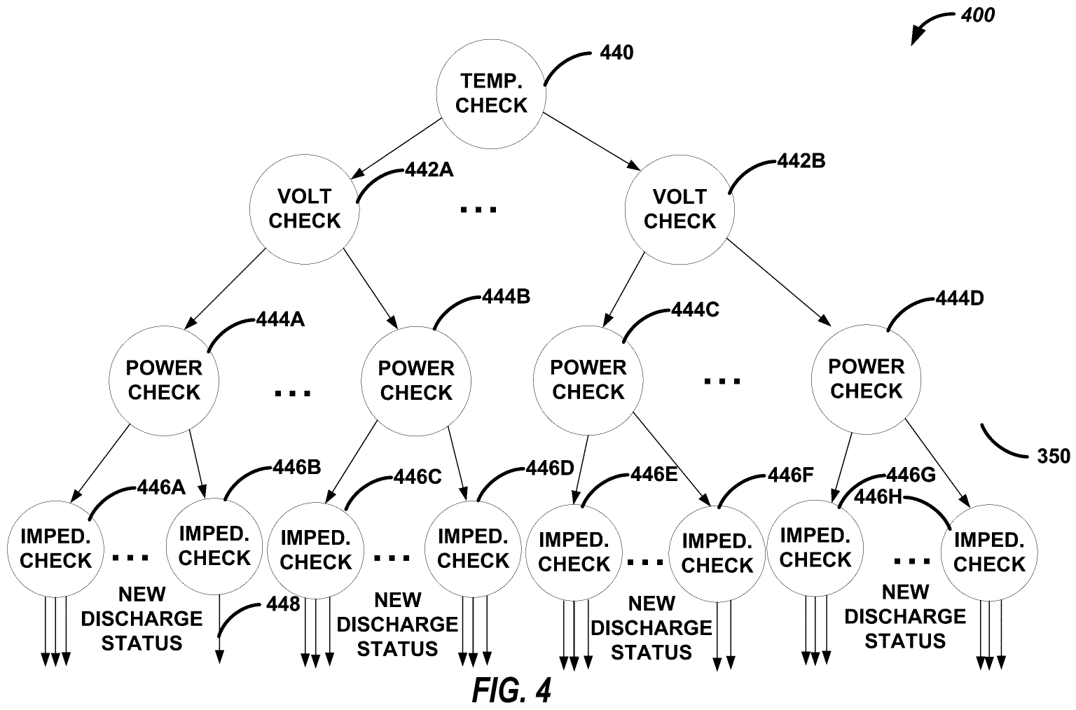

The backup battery controller 118 can operate using a neural network (NN), a tree classifier, or other model to determine a state of the indicator 132. Details regarding example NN and tree classifiers are provided regarding FIGS. 3 and 4, respectively.

FIG. 2 illustrates, by way of example, a diagram of an embodiment of a state machine 200 that controls operation of the backup battery controller 118. The state machine 200 includes states (represented by nodes depicted circles) and directed edges between the nodes (represented by arrows) that indicate transitions between the states. The states as illustrated include a backup battery unavailable state 220, a backup battery available state 222, a backup battery discharging state 224, and an impedance update state 226.

In the backup unavailable state 220 the battery backup indicator data indicates that the battery backup may not function to operate the load 126. The backup battery controller 118 can periodically check the incoming data to determine whether the backup battery 104 is capable of providing power to the load 126 for a specified amount of time. The determination can be made by a model, such as a model discussed regarding FIGS. 3 and 4. Additionally, or alternatively, the determination can be made based on a lookup table (LUT) that details ranges of parameters and a corresponding determination for of the ranges of parameters. The backup battery 104 can go from being incapable of providing power to being capable of providing power from an increase in temperature, a reduction in battery swell, charging of the backup battery, or the like. Responsive to determining the backup battery 104 is available to provide power to the load 126 (indicated by edge 230), the backup battery controller 118 can enter the backup available state 222. Responsive to determining the backup battery 104 remains unavailable to provide power to the load 126 (indicated by edge 228) the backup battery controller 118 remains in the backup unavailable state 220.

In the backup available state 222 the battery backup indicator data indicates that the battery backup can provide power to the load 126. The backup battery controller 118 can periodically check incoming data to determine whether the backup battery 104 remains capable of providing power to the load 126 for the specified amount of time. The determination can be made by the same model, LUT, or a combination thereof discussed regarding the state 220. The backup battery 104 can go from being capable of providing power to being incapable of providing power from a decrease in temperature, an increase in swell, a defect in the backup battery, or the like. Responsive to determining the backup battery 104 is unavailable to provide power to the load 136 (indicated by edge 234), the backup battery controller 118 can enter the backup unavailable state 220. Responsive to determining the backup battery 104 remains available to provide power to the load 126 (indicated by edge 232) the backup battery controller 118 remains in the backup available state 222. Responsive to main power failure (indicated by edge 236) while the backup battery controller 118 is in the backup available state 222, the backup battery controller 118 can enter the discharging state 224. The main power failure means that the main battery 102 is not providing sufficient power to the load 126. This can occur due to damage to the main battery 102, the main battery 102 capacity being drained too low to provide sufficient power, electrical disconnection of the main battery 102, or the like.

In the discharging state 224 the backup battery controller 118 can sample output from the ADC 116 to determine voltage of the backup battery 104 and can sample output from the current sense device 114. These sampled values can be used to determine the impedance of the backup battery 104. The ability of the back battery 104 to continue to provide power to the load 126 is correlated with a direct current impedance value of the backup battery 104. Also, the impedance value is indicative of the age and ware on the backup battery 104. The impedance value of the backup battery 104 can be determined at various times after the backup battery controller 118 enters the discharging state 224. The outputs of the ADC 116 and the current sense device 114 can thus be sampled at the various times.

After the main battery 102 is reconnected or otherwise begins to provide sufficient power to the load 126 (indicated by edge 238) the backup battery controller 118 can update impedance values of the backup battery 104. The impedance values determined by the backup battery controller 118 can help inform the determination whether the backup battery 104 is capable of providing power to the load 126 for the specified amount of time. After the impedance values are updated (indicated by edge 240) the backup battery controller 118 can enter the backup unavailable state 220. Because the backup battery 104 was discharged, it is assumed that the backup battery 104 will be unavailable immediately after the discharge. However, the backup battery controller 118 can quickly determine the backup battery is available after the discharge event and impedance update and enter the backup available state 222.

The model used by the backup battery controller 118 to determine the discharge status of the backup battery 104 (whether the backup battery 104 is capable of providing power to the load 126 or not) can be generated based on characterization testing on similar battery packs. Such characterization can include measuring the impedance of the backup battery 104 at different voltage points, temperatures, swells, or a combination thereof. Such characterization can also include characterizing the impedance as the battery ages.

During characterization testing, at each data point, a series of different power loads can be applied to the backup battery 104. A voltage drop of the backup battery can be recorded. A record of whether the backup battery 104 fell down to a brownout threshold or below can be made. A brownout is a drop in the magnitude of voltage in an electrical power system. The brownout threshold indicates a voltage level at which unexpected behavior of the backup battery controller 118, load circuitry 126, or another component may be realized. Brownout voltage thresholds are typically specified in device data sheets.

If the backup battery 104 did not reach the brownout threshold, then this data point can be labelled as “Discharge Available”, otherwise it is noted as “Discharge Unavailable”. A model can then be trained, in the case of an NN model, or otherwise used to configure a model, such as in the case of a tree classifier model.

FIG. 3 illustrates, by way of example, a diagram of an embodiment of a neural network (NN) 300 configured to determine if the backup battery 104 is available to provide power to the load 126. The NN 300 as illustrated includes layers of nodes 342, 344, 346, 348 connected to each other. While four layers are illustrated, more or fewer layers can be used. Also, more or fewer nodes can be used in each layer (except output layer which includes a single node 348).

The NN 300 is configured to generate a classification that indicates a new discharge status 350 of the backup battery 104. The new discharge status 350 whether the NN 300 can or cannot handle powering the load 126. The NN 300 can receive data, such as current discharge status 330 of the backup battery 104, the temperature 332 (or other sensor 124 output, such as physical pressure or battery swell), the last impedances 334, 336, 338 determined from the last discharge of the backup battery 104 (or from manufacturing if the backup battery 104 has not yet been discharged after manufacturing), and a power draw, voltage draw, alternating current (AC) impedance, or current draw from the load 340. The output of the current sense device 112 can be used as the load 340 input.

The current discharge status 330 can be initialized to a value that indicates “backup unavailable” (e.g., “0”). When the backup battery controller 118 transitions to the backup available state 222, the current discharge status 330 can be updated to a value that indicates “backup available” (e.g., “1”). When the backup battery controller 118 transitions back to the discharging state 224 or the impedance update state 226, the current discharge status 330 can be updated to a value that indicates “discharging” (e.g., “2”).

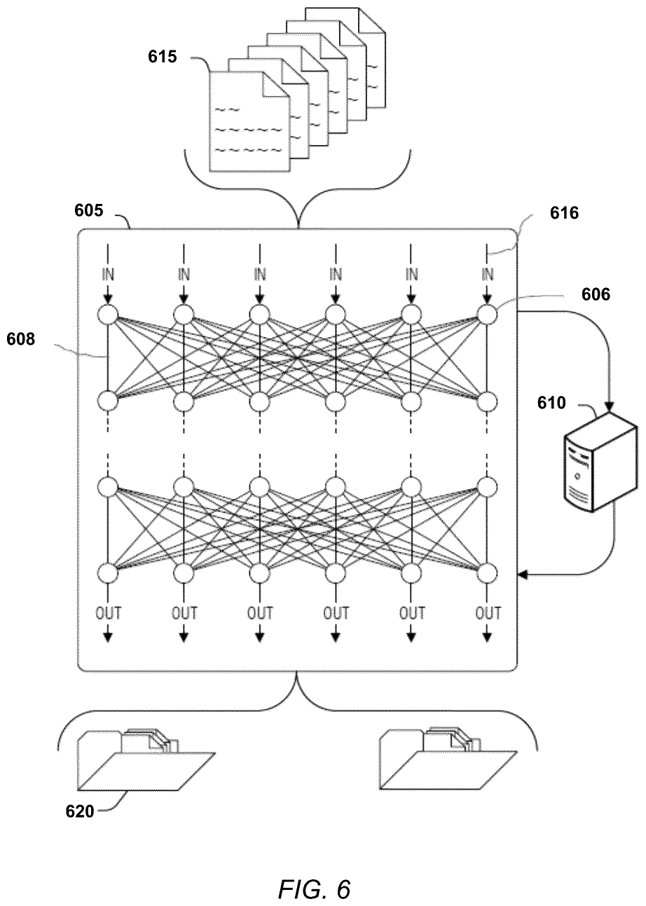

The NN 300 is sometimes called a Deep NN (DNN) because. Generating the NN includes creating a neural network with a number of inputs (e.g., one for each of the physical parameters—impedance(×3), voltage, temperature, load) and one output (ready for discharge or not ready for discharge), as well as a number of intermediary nodes. A subset of the characterization data is used to calculate the weights of the nodes on this network through a process called “training”. More details regarding training an NN are provided regarding FIG. 6. The NN can then be tested against the remainder of the characterization data to determine the accuracy of the NN model. When the NN model is accurate enough for a given use case, it can be deployed as the model for the backup battery controller 118.

FIG. 4 illustrates, by way of example, a diagram of an embodiment of a decision tree 400 model that can be used by the backup battery controller 118 to determine whether or not the backup battery 104 can provide power to the load 126. Each layer of the decision tree 400 can be delineated by one variable (e.g., temperature, voltage, load, impedance, or the like). For each combination of variable values in the characterization data, there can be a path through the tree 400 to a decision 448. One way to realize the decision tree 400 is to have a first LUT delineated by one of the variables and to have a second series of LUTs for each entry in the first LUT. Linear extrapolation can be used to estimate a result when the data input to the backup battery controller 118 does not exactly match the characterization data recorded in the tree 400.

In the tree 400 illustrated, the temperature 440 forms the root (consumes the first LUT). For each value of the temperature in the characterization data, there is an edge directed to a voltage check 442A, 442B. There can be a voltage check node in the tree 400 for each temperature value realized in the characterization data. There are edges from each voltage check 442A, 442B for each voltage value realized at the temperature in the characterization data. There can be a power check node in the tree 400 for each voltage check value at the temperature, and so on. By traversing the example tree 400 from, first the temperature value, to a voltage check node corresponding to the temperature value, to a power check node corresponding to the voltage value, to an impedance check node corresponding to a power value, a battery status corresponding to the combination of the temperature (of the backup battery 104), voltage (of the backup battery 104), power (drawn by the load 126), and impedance (of the backup battery 104) can be identified and used by the backup battery controller 118.

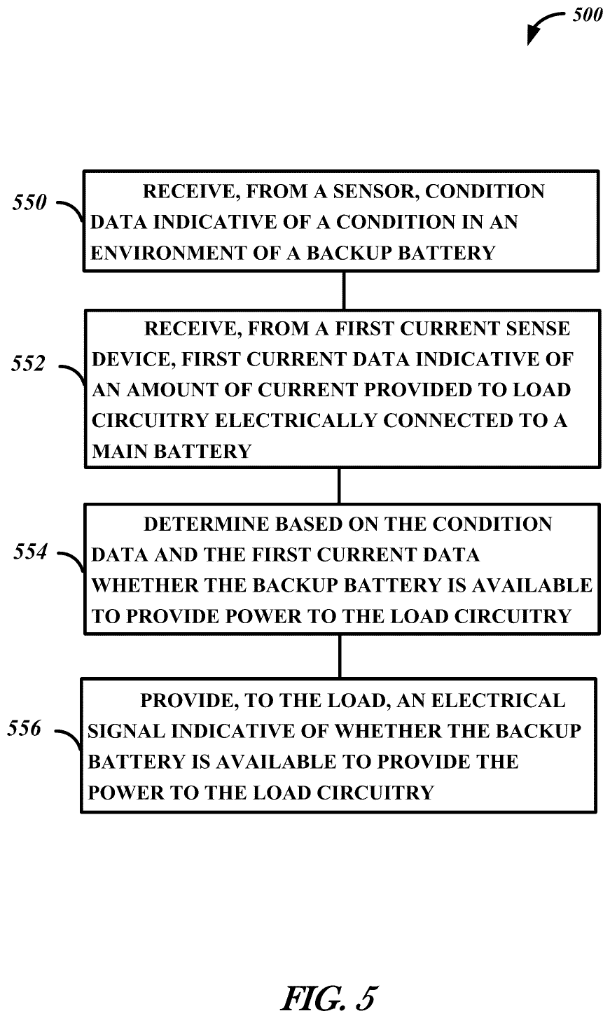

FIG. 5 illustrates, by way of example, a diagram of an embodiment of a method 500 for backup battery monitoring of a small backup battery. The method 500 as illustrated includes receiving, from a sensor, condition data indicative of a condition in an environment of a backup battery, at operation 550; receiving, from a first current sense device, first current data indicative of an amount of current provided to load circuitry electrically connected to a main battery, at operation 552; determining based on the condition data and the first current data whether the backup battery is available to provide power to the load circuitry, at operation 554; and providing, to the load, an electrical signal indicative of whether the backup battery is available to provide the power to the load circuitry, at operation 556.

The method 500 can further include responsive to power being drawn from the backup battery by the load circuitry, determining impedances for various times after the power begins being drawn. The operation 554 can be further based on the impedances.

The sensor can be a temperature sensor and the condition data can be temperature data. The sensor can be a battery swell sensor and the condition data can be physical pressure data.

The method 500 can further include providing, by an analog to digital converter (ADC), voltage data indicative of a voltage level of the backup battery. The operation 554 can be further based on the voltage level.

The operation 554 can include implementing a neural network that operates on the voltage data, the first current data, and the condition data to make the determination of whether the backup battery is available to provide power to the load circuitry. The operation 554 can include implementing a decision tree that operates on the voltage data, the first current data, and the condition data to make the determination of whether the backup battery is available to provide power to the load circuitry.

The method 500 can further include receiving, from a second current sense device, second current data indicative of a current drawn from the backup battery. The operation 554 can be further based on the second current data.

The method 500 can further include, responsive to power being drawn by the load circuitry from the backup battery, determine impedances for various times after the power begins being drawn. The operation 554 can be further based on the impedances.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The NN 300, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 606 within layers. Thus, a set of processing nodes is arranged to perform the training of the ANN 605. The NN 300 can be trained using the system.

The set of processing nodes is arranged to receive a training set 615 for the ANN 605. The ANN 605 comprises a set of nodes 606 arranged in layers (illustrated as rows of nodes 606) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 616 to be classified after ANN 605 is trained, is provided to a corresponding node 606 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 616 will be assigned into categories), for example. The training performed by the set of processing nodes 606 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 606 (e.g., neurons) are trained independently. In an example, the nodes are trained on different hardware.

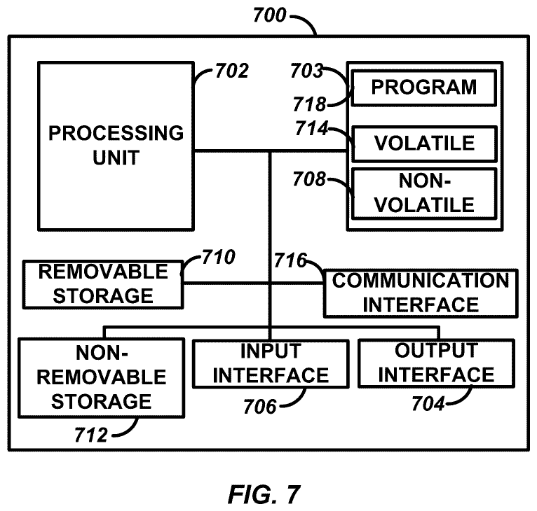

FIG. 7 is a block schematic diagram of a computer system 700 to perform search request routing, and for performing methods and algorithms according to example embodiments. Any of the components or operations of the system 100, state diagram 200, NN 300, tree classifier 400, method 500, or other component or operation can be implemented using the system 700 or a component thereof. All components of the system 700 need not be used in various embodiments.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, smart storage device (SSD), or other computing device including the same or similar elements as illustrated and described with regard to FIG. 7. Devices, such as smartphones, tablets, and smartwatches, are generally collectively referred to as mobile devices or user equipment.

Although the various data storage elements are illustrated as part of the computer 700, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may include a display device, such as a touchscreen, that also may serve as an input device. The input interface 706 may include one or more of a touchscreen, touchpad, mouse, keyboard, camera, one or more device-specific buttons, one or more sensors integrated within or coupled via wired or wireless data connections to the computer 700, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 700 are connected with a system bus 720.

Computer-readable instructions stored on a computer-readable medium are executable by the processing unit 702 of the computer 700, such as a program 718. The program 718 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 718 along with the workspace manager 722 may be used to cause processing unit 702 to perform one or more methods or algorithms described herein.

### EXAMPLES AND ADDITIONAL NOTES

Example 1 includes a circuit comprising a backup battery, a sensor electrically coupled to generate condition data indicative of a condition in an environment of the backup battery, a first current sense device coupled to generate first current data indicative of an amount of current provided to load circuitry, a backup battery controller coupled to the backup battery, sensor, and the first current sense device, the backup battery controller configured to determine based on the condition data and the first current data whether the backup battery is available to provide power to the load circuitry, and provide an electrical signal indicative of whether the backup battery is available to provide the power to the load circuitry.

In Example 2, Example 1 further includes, wherein the sensor is a temperature sensor and the condition data is temperature data.

In Example 3, at least one of Examples 1-2 further includes, wherein the sensor is a battery swell sensor and the condition data is physical pressure data.

In Example 4, at least one of Examples 1-3 further includes an analog to digital converter (ADC) configured to provide voltage data indicative of a voltage level of the backup battery, and wherein determination of whether the backup battery is available to provide power to the load circuitry is further based on the voltage level.

In Example 5, Example 4 further includes, wherein the backup battery controller implements a neural network that operates on the voltage data, the first current data, and the condition data to make the determination of whether the backup battery is available to provide power to the load circuitry.

In Example 6, at least one of Examples 4-5 further includes, wherein the backup battery controller implements a decision tree that operates on the voltage data, the first current data, and the condition data to make the determination of whether the backup battery is available to provide power to the load circuitry.

In Example 7, at least one of Examples 1-6 further includes, wherein the backup battery controller is configured to receive, from a second current sense device, second current data indicative of a current drawn from the backup battery, and the determination of whether the backup battery is available to provide power to the load is further based on the second current data.

In Example 8, at least one of Examples 1-7 further includes, wherein the backup battery controller is configured to responsive to power being drawn by the load circuitry from the backup battery, determine impedances for various times after the power begins being drawn, and the determination of whether the backup battery is available to provide power to the load circuitry is further based on the impedances.

Example 9 includes a system comprising load circuitry, a main battery configured to provide electrical power to the load circuitry, a backup battery, a backup battery monitoring circuit comprising a sensor to generate condition data indicative of a condition in an environment of the backup battery, a first current sense device to generate first current data indicative of an amount of current provided to the load circuitry, a backup battery controller configured to determine based on the condition data and the first current data whether the backup battery is available to provide power to the load circuitry, and provide an electrical signal to the load circuitry indicative of whether the backup battery is available to provide the power to the load circuitry.

In Example 10, Example 9 further includes, wherein an electrical capacity of the backup battery is at most one quarter of an average electrical power draw of the load circuitry.

In Example 11, at least one of Examples 9-10 further includes a first housing containing the load circuitry and the backup battery, and a separate, second housing containing the main battery.

In Example 12, Example 11 further includes, wherein the first housing and the second housing are body worn.

In Example 13, Example 12 further includes, wherein the load circuitry is part of an augmented reality (AR) headset.

In Example 14, at least one of Examples 9-13 further includes, wherein the sensor is a temperature sensor and the condition data is temperature data.

In Example 15, at least one of Examples 9-14 further includes an analog to digital converter (ADC) configured to provide voltage data indicative of a voltage level of the backup battery, and wherein determination of whether the backup battery is available to provide power to the load circuitry is further based on the voltage level.

In Example 16, Example 15 further includes, wherein the backup battery controller implements a neural network that operates on the voltage data, the first current data, and the condition data to make the determination of whether the backup battery is available to provide power to the load circuitry.

In Example 17, at least one of Examples 15-16 further includes, wherein the backup battery controller implements a decision tree that operates on the voltage data, the first current data, and the condition data to make the determination of whether the backup battery is available to provide power to the load circuitry.

In Example 18, at least one of Examples 9-17 further includes, wherein the backup battery controller is configured to responsive to power being drawn from the backup battery by the load circuitry, determine impedances for various times after the power begins being drawn, and the determination the determination of whether the backup battery is available to provide power to the load circuitry is further based on the impedances.

Example 19 includes a machine-readable medium including instructions that, when executed by a machine, cause the machine to perform operations for backup battery monitoring, the operations comprising receiving, from a sensor, condition data indicative of a condition in an environment of a backup battery, receiving, from a first current sense device, first current data indicative of an amount of current provided to load circuitry electrically connected to a main battery, determining based on the condition data and the first current data whether the backup battery is available to provide power to the load circuitry, and providing, to the load, an electrical signal indicative of whether the backup battery is available to provide the power to the load circuitry.

In Example 20, Example 19 further includes, wherein the operations further comprise responsive to power being drawn from the backup battery by the load circuitry, determining impedances for various times after the power begins being drawn, and the determination of whether the backup battery is available to provide power to the load circuitry is further based on the impedances.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine. Thus, a module can include software, hardware that executes the software or is configured to implement a function without software, firmware, or a combination thereof.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A circuit comprising:
a backup battery;
a sensor electrically coupled to generate condition data indicative of a condition in an environment of the backup battery;
a first current sense device coupled to generate first current data indicative of an amount of current provided to load circuitry;
a backup battery controller coupled to the backup battery, the sensor, and the first current sense device, the backup battery controller configured to:
determine based on the condition data and the first current data whether the backup battery is available to provide power to the load circuitry; and
provide an electrical signal indicative of whether the backup battery is available to provide the power to the load circuitry.

2. The backup battery monitor circuit of claim 1, wherein the sensor is a temperature sensor and the condition data is temperature data.

3. The backup battery monitor circuit of claim 1, wherein the sensor is a battery swell sensor and the condition data is physical pressure data.

4. The backup battery monitor circuit of claim 1, further comprising:
an analog to digital converter (ADC) configured to provide voltage data indicative of a voltage level of the backup battery; and
wherein determination of whether the backup battery is available to provide power to the load circuitry is further based on the voltage level.

5. The backup battery monitor circuit of claim 4, wherein the backup battery controller implements a neural network that operates on the voltage data, the first current data, and the condition data to make the determination of whether the backup battery is available to provide power to the load circuitry.

6. The backup battery monitor circuit of claim 4, wherein the backup battery controller implements a decision tree that operates on the voltage data, the first current data, and the condition data to make the determination of whether the backup battery is available to provide power to the load circuitry.

7. The backup battery monitor circuit of claim 1, wherein the backup battery controller is configured to receive, from a second current sense device, second current data indicative of a current drawn from the backup battery, and the determination of whether the backup battery is available to provide power to the load is further based on the second current data.

8. The backup battery monitor circuit of claim 1, wherein the backup battery controller is configured to:
responsive to power being drawn by the load circuitry from the backup battery, determine impedances for various times after the power begins being drawn; and
the determination of whether the backup battery is available to provide power to the load circuitry is further based on the impedances.

9. A system comprising:
load circuitry;
a main battery configured to provide electrical power to the load circuitry;
a backup battery;
a backup battery monitoring circuit comprising:
a sensor to generate condition data indicative of a condition in an environment of the backup battery;
a first current sense device to generate first current data indicative of an amount of current provided to the load circuitry;
a backup battery controller configured to:
determine based on the condition data and the first current data whether the backup battery is available to provide power to the load circuitry; and
provide an electrical signal to the load circuitry indicative of whether the backup battery is available to provide the power to the load circuitry.

10. The system of claim 9, wherein an electrical capacity of the backup battery is at most one quarter of an average electrical power draw of the load circuitry.

11. The system of claim 9, further comprising:
a first housing containing the load circuitry and the backup battery; and
a separate, second housing containing the main battery.

12. The system of claim 11, wherein the first housing and the second housing are body worn.

13. The system of claim 12, wherein the load circuitry is part of an augmented reality (AR) headset.

14. The system of claim 9, wherein the sensor is a temperature sensor and the condition data is temperature data.

15. The system of claim 9, further comprising:
an analog to digital converter (ADC) configured to provide voltage data indicative of a voltage level of the backup battery; and
wherein determination of whether the backup battery is available to provide power to the load circuitry is further based on the voltage level.

16. The system of claim 15, wherein the backup battery controller implements a neural network that operates on the voltage data, the first current data, and the condition data to make the determination of whether the backup battery is available to provide power to the load circuitry.

17. The system of claim 15, wherein the backup battery controller implements a decision tree that operates on the voltage data, the first current data, and the condition data to make the determination of whether the backup battery is available to provide power to the load circuitry.

18. The system of claim 9, wherein the backup battery controller is configured to:
responsive to power being drawn from the backup battery by the load circuitry, determine impedances for various times after the power begins being drawn; and
the determination the determination of whether the backup battery is available to provide power to the load circuitry is further based on the impedances.

19. A non-transitory machine-readable medium including instructions that, when executed by a machine, cause the machine to perform operations for backup battery monitoring, the operations comprising:
receiving, from a sensor, condition data indicative of a condition in an environment of a backup battery;
receiving, from a first current sense device, first current data indicative of an amount of current provided to load circuitry electrically connected to a main battery;
determining based on the condition data and the first current data whether the backup battery is available to provide power to the load circuitry; and
providing, to the load, an electrical signal indicative of whether the backup battery is available to provide the power to the load circuitry.

20. The non-transitory machine-readable medium of claim 19, wherein the operations further comprise:
responsive to power being drawn from the backup battery by the load circuitry, determining impedances for various times after the power begins being drawn; and
the determination of whether the backup battery is available to provide power to the load circuitry is further based on the impedances.
